(19) United States
(12) Patent Application Publication
(10) Pub. No.: US 2021/0219776 A1
(43) Pub. Date: Jul. 22, 2021

(54) Slow Cooker Wireless Network Module

(71) Applicants: Patrick T Mulvaney, Richmond, VA (US); Ernest B Pryor, JR., Maidens, VA (US); Paula L Pennington, Mechanicsville, VA (US)

(72) Inventors: Patrick T Mulvaney, Richmond, VA (US); Ernest B Pryor, JR., Maidens, VA (US); Paula L Pennington, Mechanicsville, VA (US)

(21) Appl. No.: 16/747,279

(22) Filed: Jan. 20, 2020

(51) Int. Cl. A47J 36/32; H04W 4/38; A47J 36/04; A47J 36/10; A47J 27/00

(52) U.S. Cl. CPC A47J 36/321; H04W 4/38; A47J 2202/00; A47J 36/10; A47J 27/004; A47J 36/04

(57) ABSTRACT

The present disclosure describes slow cookers. A slow cooker includes an outer housing, a heating element, a container, a lid, a network housing unit, and a network antenna. The network antenna is located in a top portion of the network housing unit such that the network antenna resides above a maximum liquid fill line within the removable container or above a housing rim of the outer housing. The network may be a Wi-Fi network. Systems associated with operation of the slow cooker are also provided herein.

### FIELD OF THE DISCLOSURE

The present disclosure relates generally to a kitchen appliance, and more particularly to a wireless network-enabled slow cooker for cooking foodstuff.

### BACKGROUND

Kitchen appliances such as slow cookers are well-known. Currently, some slow cookers provide for interaction with smart devices via blue tooth or other electronic control, such as a network according to one or more of the IEEE 802.11x family of standards (commonly referred to as Wi-Fi networks). However, these slow cookers can experience poor network performance that can result in network interference. Thus, network-enabled slow cookers having improved communications performance and/or reduced interference may be desired.

### SUMMARY

An embodiment of the present disclosure is directed to a wireless network-enabled slow cooker. The slow cooker may include an outer housing, a heating element, a container, a lid, a network housing, and a network antenna. The outer housing has a base and a side wall extending therefrom. The side wall has an exterior surface and an opposing interior surface with at least portions of the interior surface of the side wall and base defining a cavity within the outer housing. The outer housing may have a housing rim defining an opening to the cavity. The heating element is disposed within the outer housing proximate to the cavity to heat the cavity. The container has a generally hollow interior and a container rim defining an opening for accessing the interior thereof. The interior of the container is capable of retaining contents therein. The container is sized and shaped to removably fit within the cavity of the outer housing. The lid may be sized and shaped to at least partially cover the opening of the container when placed on the container. The network housing unit is mounted to the exterior surface of the side wall of the outer housing. The network antenna is located in a top portion of the network housing unit such that the network antenna resides above a maximum liquid fill line within the container. The network antenna is in communication with a processor and memory storing non-transitory computer-readable instructions that, when executed by the processor, cause the processor to perform operations including: capturing data with one or more sensors within the outer housing and wirelessly transmitting, via a network, notification messages based on the captured data to a remote device.

In another embodiment of the present disclosure, the slow cooker may include an outer housing, a heating element, a container, a lid, a network housing, and a network antenna. The outer housing has a base and a side wall extending therefrom. The side wall has an exterior surface and an opposing interior surface with at least portions of the interior surface of the side wall and base defining a cavity within the outer housing. The outer housing has a housing rim defining an opening to the cavity. The heating element is disposed within the outer housing proximate to the cavity to heat the cavity. The container has a generally hollow interior and a container rim defining an opening for accessing the interior thereof, the interior being capable of retaining contents therein. The container is sized and shaped to removably fit within the cavity of the outer housing. The lid may be sized and shaped to at least partially cover the opening of the container when placed on the container. The network housing unit is mounted to the exterior surface of the side wall of the outer housing. The network module is located in a top portion of the network housing unit such that the network antenna resides above the housing rim of the outer housing. The network antenna is in communication with a processor and memory storing non-transitory computer-readable instructions that, when executed by the processor, cause the processor to perform operations including: capturing data with one or more sensors within the outer housing and wirelessly transmitting, via a network, notification messages based on the captured data to a remote device.

In a further embodiment of the present disclosure, the slower cooker may include an outer housing, a heating element, a container, a lid, a network housing, and a network antenna. The outer housing has a base and a side wall extending therefrom. The side wall has an exterior surface and an opposing interior surface with at least portions of the interior surface of the side wall and base defining a cavity within the outer housing. The outer housing may have a housing rim defining an opening to the cavity. The heating element is disposed within the outer housing proximate to the cavity to heat the cavity. The container has a generally hollow interior and a container rim defining an opening for accessing the interior thereof, the interior being capable of retaining contents therein. The container is sized and shaped to removably fit within the cavity of the outer housing. The lid may be sized and shaped to at least partially cover the opening of the container when placed on the container. The network housing unit is mounted to the exterior surface of the side wall of the outer housing and is configured to serve as a lid rest. The network antenna is located in the network housing unit. The network antenna is in communication with a processor and memory storing non-transitory computer-readable instructions that, when executed by the processor, cause the processor to perform operations including: capturing data with one or more sensors within the outer housing and wirelessly transmitting, via a network, notification messages based on the captured data to a remote device.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1 is a front view of a slow cooker according to some embodiments of the present disclosure.

FIG. 2 is a rear view of the slow cooker of FIG. 1.

FIG. 3 is a top view of the slow cooker of FIG. 1 with the lid and container removed.

FIG. 4 is a side view of the slow cooker of FIG. 1.

FIG. 5 is a side view of the slow cooker of FIG. 1 with the outer housing removed.

FIG. 6 is an enlarged view of the network housing unit mounted on the outer housing of the slow cooker of FIG. 1 with part of the network housing unit removed to show the network antenna located therein and above a maximum liquid fill line within the container of the slow cooker.

FIG. 7A is a front perspective view of a slow cooker according to some embodiments of the present disclosure with the lid closed.

FIG. 7B is a rear perspective view of the slow cooker of FIG. 7A.

FIG. 8A is a front perspective view of the slow cooker of FIG. 7A according to some embodiments of the present disclosure with the lid opened and held upright by the lid rest.

FIG. 8B is a rear perspective view of the slow cooker of FIG. 8A.

FIG. 9 is a block diagram of certain components of a network-enabled slow cooker system according to some embodiments of the present disclosure.

FIG. 10 is a block diagram of certain components of a computing device according to some embodiments of the present disclosure.

### DETAILED DESCRIPTION

The present disclosure now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

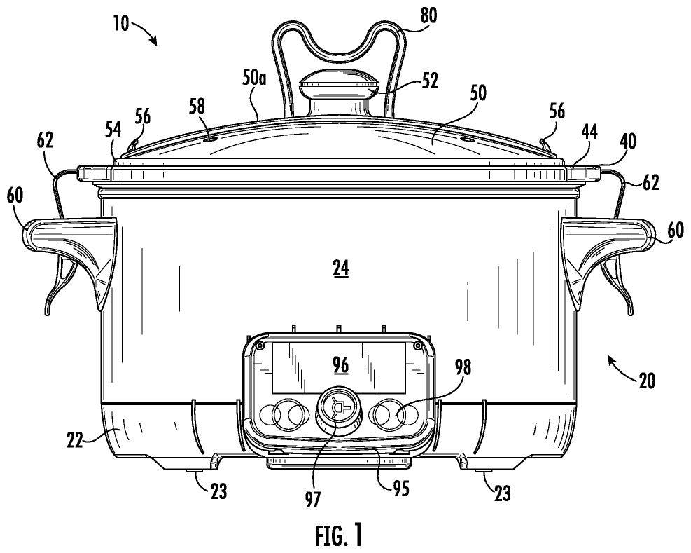

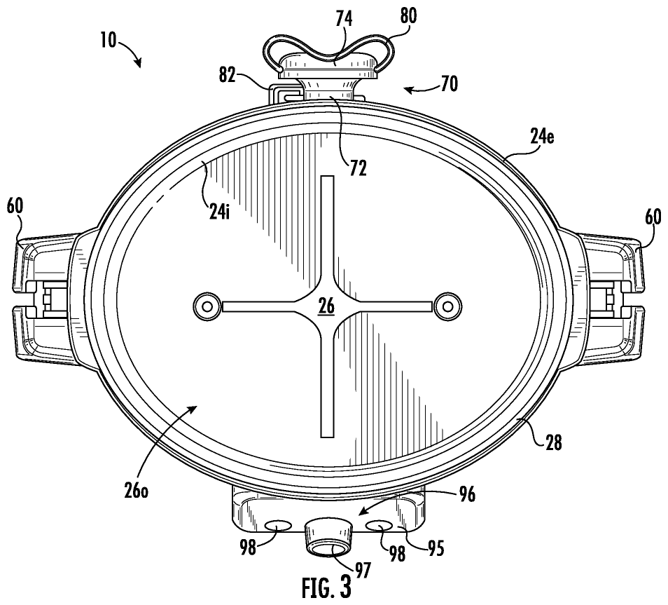

Referring now to the figures, a wireless network-enabled slow cooker, designated broadly at 10, is illustrated in FIGS. 1-10. The slow cooker 10 includes an outer housing 20, a heating element 30, a container 40, a lid 50, a network housing unit 70, and a network antenna 76. In some embodiments, the slow cooker 10 may further include a pair of side handles 60 and a wire-form lid rest 80. Each of these elements will be discussed in further detail below. It is noted that within or on the outer housing 20, the slow cooker 10 may include additional components for the power and operation thereof, such as, electronics to control operation, sensors, and the like. These components may be of conventional construction and need not be described in detail herein.

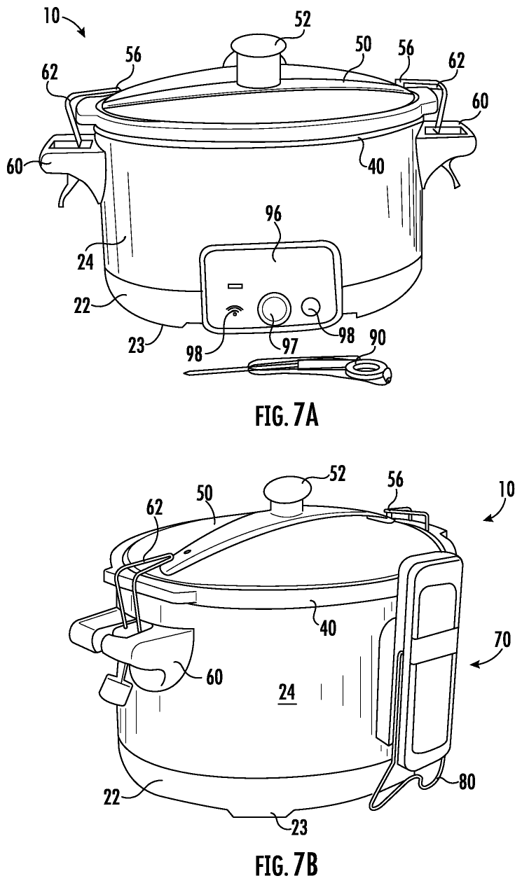

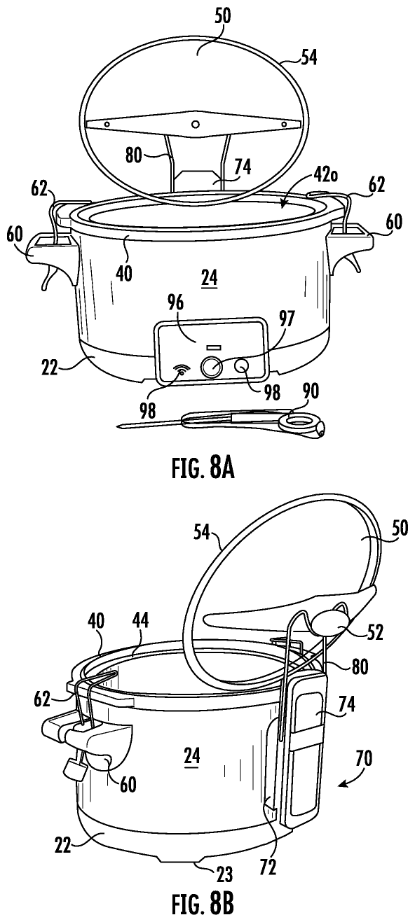

Referring to FIGS. 1-5, the outer housing 20 has a base 22 and a side wall 24 extending therefrom (see also, e.g., FIGS. 7A-8B). The side wall 24 has an exterior surface 24e and an opposing interior surface 24i. At least portions of the interior surface 24i of the side wall 24 and the base 22 define a cavity 26 within the outer housing 20. The outer housing 20 further has a housing rim 28 that defines an opening 26o to the cavity 26. In some embodiments, the base 22, the side wall 24, and the housing rim 28 are generally oval or elliptical in shape when viewed from above or below. While the oval or elliptical shape is illustrated herein, the slow cooker 10 may have a different shape, for example, circular or rectangular in plan view. The outer housing 20 may be formed of a metallic material.

In some embodiments, the base 22 may include several generally spaced apart protrusions (or feet) 23 extending downwardly from a bottom surface thereof for supporting the slow cooker 10 on a support surface (not shown), such as a countertop, and spacing the bottom surface of the base 22 at least slightly above the support surface.

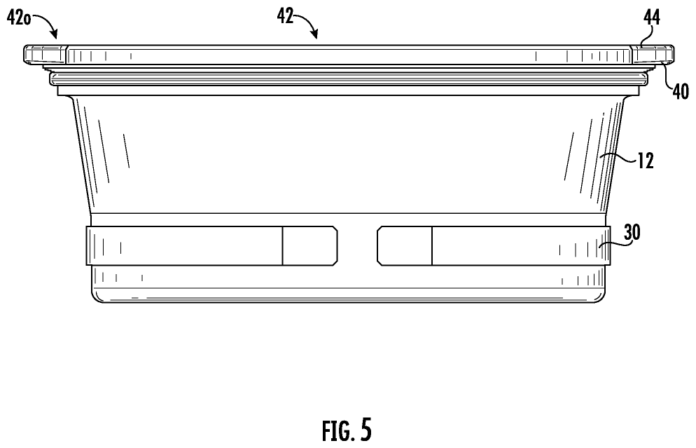

The heating element 30 is disposed within the outer housing 20 proximate to the cavity 26 (see FIG. 5). The heating element 30 may reside circumferentially about a lower portion of the container 40. The heating element 30 is designed to heat the cavity 26 (and subsequently the container 40 within the cavity 26). Different types of heating elements may be used, provided the heating element 30 functions to heat the cavity 26 of the outer housing 20. As discussed in further detail below, the heating element 30 may be controlled remotely (e.g., wirelessly) through, for example, the network antenna 76.

The container 40 has a generally hollow interior 42. In some embodiments, the container 40 comprises a container rim 44 that defines an opening 42o for accessing the interior 42 of the container 40. The interior 42 of the container 40 is capable of retaining contents (e.g., foodstuff) therein. In some embodiments, the container rim 44 may be a top or upper-most horizontal edge of a side wall of the container 40. Alternatively, the container rim 44 may be at least a portion of a ledge spaced inwardly and at least slightly downwardly from the upper-most horizontal edge of the side wall of the container 40.

The container 40 is sized and shaped to removably fit within the cavity 26 of the outer housing 20. More specifically, an exterior of the container 40 is at least slightly smaller than the cavity 26 of the outer housing 20 such that at least a majority of the container 40 fits within the cavity 26 of the outer housing 20. This allows the container 40 to be easily removed from the outer housing 20 to facilitate cleaning of the container 40 without exposing the outer housing 20, and specifically the heating element 30 and other electrical components of the slow cooker 10, to water and/or cleaning detergents or solvents. In some embodiments, the container 40 may be formed of a ceramic material. However, the container 40 may be made of a different material that is capable of functioning as described herein.

The lid 50 is sized and shaped to at least partially cover the opening 42o of the container 40 when placed on the container 40. In some embodiments, when placed on the container rim 44, the lid 50 covers the entire opening 42o of the container 40 such that the entire outer periphery of the lid 50 engages and/or is placed adjacent to the container rim 44. For example, as shown in FIGS. 1, 2 and 4, the lid 50 may have an outer periphery and a diameter that is at least slightly smaller than an outer periphery and a diameter of the container rim 44 (see also, e.g., FIGS. 7A-7B). This allows at least a portion of the outer periphery of the lid 50 to rest on a ledge (or container rim 44) that is at least slightly inwardly from the outer periphery of the container 40. In some embodiments, however, the outer periphery of the lid 50 may match or be about the same size as the outer periphery of the container 40.

In some embodiments, the lid 50 may comprise a knob-type handle 52. The handle 52 may extend outwardly or upwardly from an exterior surface 50a of the lid 50. In some embodiments, the handle 52 may be configured to engage the wire-form lid rest 80 (see, e.g., FIGS. 8A-8B). In some embodiments, the lid 50 may also comprise at least two hook features 56. As discussed in further detail below, the hook features 56 may be used to help seal and/or lock the lid 50 onto the container 40 to prevent leakage of any contents from the container 40.

In some embodiments, the lid 50 may further comprise a gasket 54. The gasket 54 may extend around and/or below one of the outer periphery or edge of the lid 50 and the container rim 44. In some embodiments, the gasket 54 may help to facilitate a sealing engagement with the container 40. More specifically, when the lid 50 is removed from the container 40, the gasket 54 may extend around and/or be attached to the outer periphery or edge of the lid 50 or the interior surface of the lid 50 proximate the outer edge thereof. Alternatively, the gasket 54 may extend around and/or be attached to the container rim 44. The gasket 54 may be formed of a resiliently flexible material, such as an elastomeric or rubber material. In some embodiments, the gasket 54 may be at least slightly compressible to create a seal between the lid 50 and the container rim 44 when the lid 50 is properly placed on the container 40.

In some embodiments, the lid 50 has at least a slightly arcuate shape, such that the exterior surface 50a is generally convex and the interior surface of the lid 50 is generally concave. In some embodiments, the lid 50 is predominantly made of glass. However, the lid 50 may be made of a different material, preferably a transparent or translucent material, such as a polymeric material.

In some embodiments, the lid 50 may further comprise one or more openings 58. Each opening 58 may be sized and configured to allow the insertion of a temperature probe accessory 90 into the interior 42 of the container 40 (see, e.g., FIGS. 7A and 8A). The temperature probe accessory 90 is discussed in further detail below.

Still referring to FIGS. 1-5, in some embodiments of the present invention, the slow cooker 10 may comprise a pair of side handles 60. The handles 60 are mounted to the exterior surface 24e of the side wall 24 of the outer housing 20 and extend outwardly therefrom. In some embodiments, the handles 60 may be equidistantly spaced-apart around the side wall 24 of the outer housing 20; however, the handles 60 are not limited to such an orientation or configuration.

Together, the handles 60 are configured to allow the slow cooker 10 to be relatively easily lifted and/or transported, while simultaneously sealing and/or locking the lid 50 onto the container 40 to prevent leakage of any contents within the container 40. For example, in some embodiments, each side handle 60 may comprise a wire lid clip 62. The wire lid clip 62 may be pivotable between an engaged position (see, e.g., FIGS. 7A and 7B) and a disengaged position (see, e.g., FIGS. 8A and 8B). In the engaged position, at least a portion of each wire lid clip 62 interlocks with a respective hook feature 56 on the lid 50 to retain the lid 50 in a sealed and/or locked engagement with the container 40 (i.e., the container rim 44). To further protect against the leakage of the contents from the interior of the container 40, in some embodiments, when the wire lid clips 62 are in the engaged position, the gasket 54 extending around the outer periphery of the lid 50 may become at least partially compressed between the lid 50 and the container rim 44. In the disengaged position, each wire lid clips 62 is spaced apart from the respective hook feature 56, thus allowing the lid 50 to be removed from the container 40.

Engaging the wire lid clips 62 with the hook features 56 to retain the lid 50 in a sealed and/or locked engagement with the container 40 allows a user to grasp the handles 60 to pick up and/or transport the slow cooker 10 without the contents spilling or exiting from the interior 42 of the container 40. Therefore, each handle 60 is sufficiently sized and/or shaped to allow a user to insert at least a portion of his/her hand underneath. In some embodiments, the handles 60 may be formed of a light-weight, high-strength material, for example, a polymeric or metallic material.

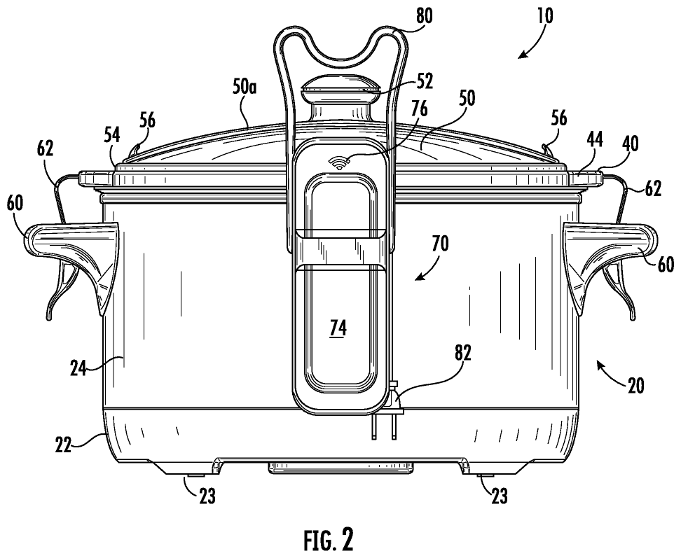

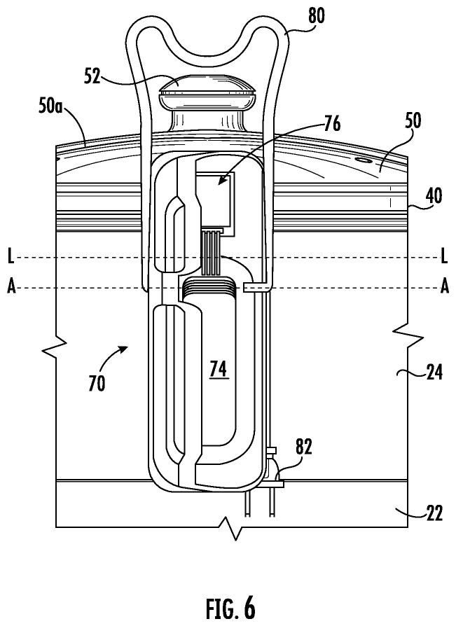

As shown in FIG. 6, and discussed in further detail below, the wireless network-enabled slow cooker 10 of the present disclosure further includes a network housing unit 70 (see also, e.g., FIGS. 2-4, 7B, and 8B) that is mounted to the exterior surface 24e of the side wall 24 of the outer housing 20 of the slow cooker 10. Located within the network housing unit 70 is network antenna 76. In some embodiments, the network housing unit 70 may be configured to serve as a lid rest (see, e.g., FIGS. 8A-8B).

Referring now to FIGS. 7A-7B and FIGS. 8A-8B, in some embodiments, the slow cooker 10 of the present disclosure may further comprise a wire-form lid rest 80 (see also, e.g., FIGS. 1-4 and 6). The wire-form lid rest 80 may be pivotally coupled to the network housing unit 70 about a central axis (A-A). As shown in FIGS. 7A-7B, when the slow cooker 10 is in use (i.e., cooking/heating foodstuff), the lid rest 80 may be pivoted to a “down” position. As shown in FIGS. 8A-8B, when the lid 50 is removed from the slow cooker 10, the lid rest 80 may be pivoted to an “up” position. In some embodiments, the lid rest 80 is configured to engage the knob-type handle 52 on the lid 50 and hold the lid 50 in an upright position.

As shown in FIG. 7A and FIG. 8A, in some embodiments, the slow cooker 10 may comprise a temperature probe accessory 90. As discussed above, the temperature probe 90 may be inserted into the one or more openings 58 in the lid 50. In some embodiments, the temperature probe 90 may be used to detect the temperature within the container 40 (or the temperature of the contents within the container 40) and transmit the temperature readings to a processor 110 (which then may be communicated wirelessly to a remote device through the network antenna 76). A user may change the settings of the slow cooker 10 based on the information received from the temperature probe 90 (e.g., through a mobile application on a remote device). An exemplary temperature probe 90 that may be used with the slow cooker 10 of the present disclosure is described in Hamilton Beach's U.S. patent application Ser. No. 11/933,478, the disclosure of which is incorporated by reference herein in its entirety

In some embodiments, the slow cooker 10 further comprises a control panel 95 with an LCD display 96 mounted to the exterior surface 24e of the side wall 24 of the outer housing 20 (see, e.g., FIGS. 1, 3, 4, 7A, and 8A). The control panel 95 is in communication with the processor 110 (and the heating element 30), and is configured to be manually controlled by a user or configured to transmit and receive data and/or instructions that were remotely communicated via the network antenna 76. As discussed in further detail below, the control panel 95 and/or network antenna 76 may be in further communication with a processor 110 and configured to transmit and receive data and/or instructions from the processor 110.

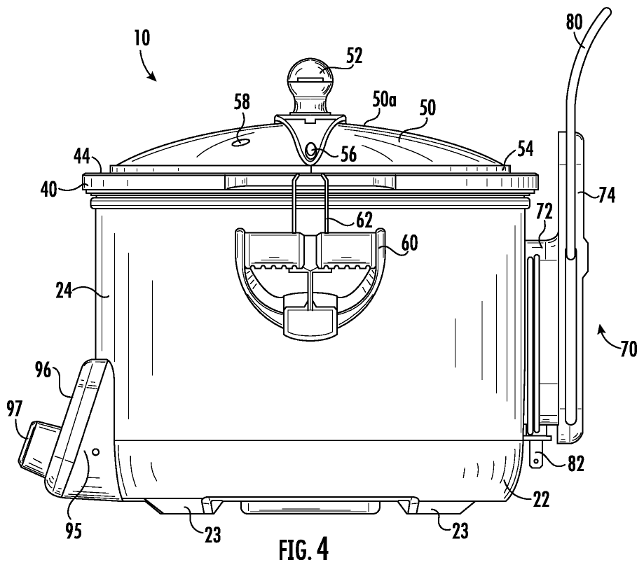

In some embodiments, the control panel 95 may comprise a push-button rotary encoder 97. In some embodiments, the LCD display 96 may comprise one or more touch sensor buttons 98. For example, the LCD display 96 may comprise a touch sensor “cancel” button and a touch sensor “Wi-Fi” button. Each of the touch sensor buttons may be back-lit with a different color LED illumination, e.g., white for the cancel button and bi-color for the Wi-Fi button. The LCD display 96 may be used to display a variety of information about the slow cooker 10 including, but not limited to, cook time, target temperature, probe temperature, error messages, and other slow cooker settings. In some embodiments, the face of the LCD display 96 may be angled for easy viewing by a user (see, e.g., FIG. 4).

As discussed above, the wireless network-enabled slow cooker 10 of the present disclosure further includes a network housing unit 70 and network antenna 76. The network housing unit 70 is mounted to the exterior surface 24e of the side wall 24 of the outer housing 20 of the slow cooker 10. In some embodiments, the network housing unit 70 comprises a mount section 72 and a tower section 74. As shown in FIG. 4, the mount section 72 of the network housing unit 70 is mounted to the exterior surface 24e of the side wall 24 and extends outwardly from the outer housing 20, thereby spacing the tower section 74 of the network housing unit 70 away from the metallic outer housing 20, and specifically away from the electrical components of the slow cooker 10 and the liquid contents within the container 40. At least a portion of the tower section 74 extends above a maximum liquid fill line (L-L) within the container 40 and/or above the housing rim 28 of the outer housing 20. In some embodiments, the mount section 72 may provide for a location on which to wrap a power cord 82 of the slow cooker 10 (see, e.g., FIG. 4), for example, during storage of the slow cooker 10 when the slow cooker 10 is not in use.

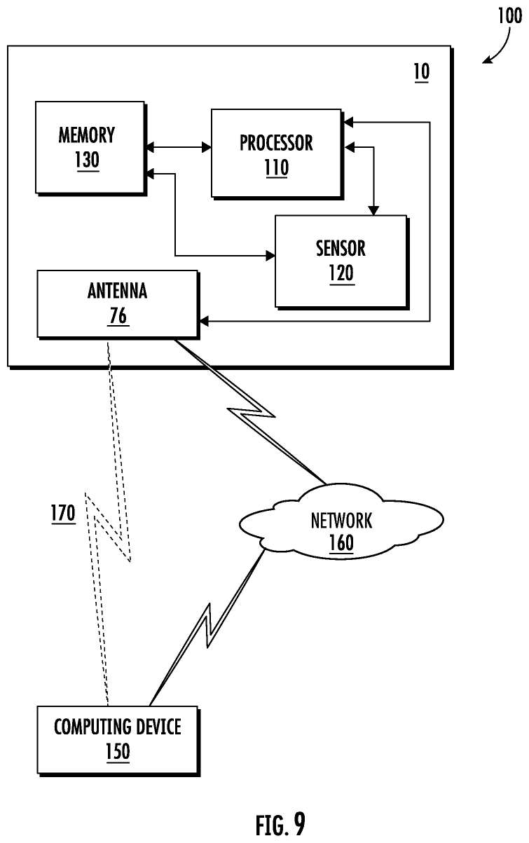

In FIG. 6, part of the network housing unit 70 is removed to show the network antenna 76 located in a top portion of the tower section 74 of the network housing unit 70. As discussed in further detail herein, the network antenna 76 may be configured to wirelessly transmit and receive data/information to a remote device, such as a computing device (e.g., computing device 150 of FIG. 9). In some embodiments, the network may be a Wi-Fi network.

The network antenna 76 may communicate with the remote device (FIG. 9), thereby allowing the functionality of the slow cooker 10 to be controlled remotely. For example, where the remote device is a smartphone, tablet, smartwatch, or other like smart device (or monitoring/control device or service, such as voice assistants), the functionality of the slow cooker 10 may be controlled via a mobile application operating on the smart device. In some embodiments, the slow cooker 10 further comprises one or more sensors 120 within the outer housing 20 (see, e.g., FIG. 9). The one or more sensors 120 (in addition to the temperature probe 90) are configured to capture and communicate data to the processor 110 (e.g., a host microprocessor (HMUC)) to be transmitted to the remote device via the network antenna 76. Likewise, in some embodiments, the network antenna 76 is configured to receive one or more control instructions from the remote device, for example, to control or change at least one operational setting for the slow cooker 10 (see, e.g., FIG. 9), and transmit to the processor 110. In some embodiments, the slow cooker 10 of the present disclosure may comprise a network module (not shown) that resides in a separate location from the network antenna 76. For example, the network module may be housed on the main circuit board assembly of the slow cooker 10 (e.g., located in the base 22 or the control panel 95 of the slow cooker 10).

Slow cookers configured to communicate with a remote device that are currently in the market include a network module (and/or an antenna) in the base of the slow cooker with the other electrical components of the slow cooker. This places the network module/antenna below the foodstuff, particularly liquid, within the slow cooker being heated or cooked, which can cause poor network performance and/or can result in network interference.

In contrast, in the illustrated embodiment, the network antenna 76 of the present disclosure resides above a maximum liquid fill line (L-L) within the container 40 and above the housing rim 28 of the outer housing 20. The purpose is to place the network antenna 76 in a location above the maximum liquid fill line (L-L) and the metallic outer housing 20 and/or away from the electrical components in the base 22 of the slow cooker 10. The placement of the network antenna 76 for the slow cooker 10 of the present disclosure may help to mitigate or eliminate interference and/or poor performance of the network transmission signal which can be caused by the liquid contents within the container 40, the metallic outer housing 20, and/or the internal electrical components of the slow cooker 10.

Referring now to FIG. 9, a system 100 for controlling a wireless network-enabled slow cooker 10 is also provided herein. In some embodiments, the slow cooker 10 may further include a processor 110 (as discussed herein), one or more sensors 120 installed within the slow cooker 10, e.g., the temperature probe accessory 90 as described herein, and memory 130 communicatively coupled to the processor 110 and storing non-transitory computer-readable instructions that, when executed by the processor 110, cause the processor 110 to perform one or more operations. As shown in FIG. 9 and as discussed herein, the network antenna 76, which may enable communications between the slow cooker 10 and one or more remote devices. Although the antenna 76 is shown as communicatively coupled to the processor 110 in FIG. 9, it is understood that in some embodiments, one or more input/output (I/O) devices may be present therebetween. For example, a transceiver may be present in a communicative pathway between the antenna 76 and the processor 110, which may receive a first data signal from the processor 110 and generate a second data signal for communication via the antenna 76. The transceiver may receive a first data signal from the antenna 76 and generate and communicate a second data signal to the processor 110. In addition, a transceiver may be present in a communicative pathway between the control panel 95 and the processor 110, which may receive a first data signal from the processor 110 and generate a second data signal for communication via the control panel 95. The transceiver may receive a first data signal from the control panel 95 and generate and communicate a second data signal to the processor 110.

In the example of FIG. 9, a remote device may be a computing device 150 that may also be present in the system 100 for controlling (or monitoring the progress of) the slow cooker 10. The computing device 150 may be configured to receive, from the slow cooker 10 and/or components thereof (e.g., the sensors 120 and/or the temperature probe accessory 90), data via the network 160 (e.g., a Wi-Fi network). For example, such data can include an amount of remaining time on a timer (e.g., an amount of time remaining before the slow cooker 10 changes to a “keep warm” or “off” setting), a cooking temperature (e.g., an operating temperature of the slow cooker 10), a temperature of a foodstuff being cooked in the slow cooker 10, and/or other telemetry data.

The computing device 150 may also be configured to communicate, to the slow cooker 10, commands, such as commands to enable a setting, disable a setting, modify a setting (e.g., increase a cooking temperature, decrease a cooking temperature), turn on the slow cooker 10, turn off the slow cooker 10, and/or other such commands (e.g., operational settings).

The network 160 may provide a communicative connection between the slow cooker 10 and the computing device 150. For example, network 160 may be the Internet or another TCP/IP protocol network such as a wide area network (WAN) or local area network (LAN) or intranet. Network 160 could be a wireless network that implements one or more telecommunications protocols and/or standards, such as Code Division Multiple Access (CDMA), Global System for Mobile Communications (GSM), Long-Term Evolution (LTE), 802.11 standards (Wi-Fi), Bluetooth, Near Field Communications (NFC), etc. In some embodiments, the computing device 150 and/or the slow cooker 10 may instantiate an ad-hoc device-to-device communications network, as indicated by direct communications link 170, and the computing device 150 and the slow cooker 10 may communicate via the direct communications link 170.

In some embodiments, the one or more operations performed by the processor 110 may include capturing data with the one or more sensors 120 and/or temperature probe accessory 90 and wirelessly transmitting, via the network 160, notification messages based on the captured data to a remote device 150. In some embodiments, the operations performed by the processor 110 may also include receiving one or more control instructions from the remote device 150 based on the captured data and controlling at least one operational setting for the slow cooker 10 based on the received one or more control instructions.

In some embodiments, the data captured by the sensors 120 includes, but is not limited to, monitoring cook temperature, estimating cook duration or end time, and speed of heating. In some embodiments, the cook (operational) settings for the slow cooker 10 that may be controlled include, but are not limited to, cook temperature, cook time (duration), and powering off. In some embodiments, the remote device 150 is a smart device (e.g., smartphone, smartwatch or tablet) or other monitoring/control device or service, such as, a voice assistant. In some embodiments, the remote device 150 comprises a mobile dashboard, application, or service associated with the slow cooker 10. In some embodiments, the sensors 120 may be used to monitor the slow cooker's telemetry data (e.g., time and temperature). This telemetry data may then be reported to a user (e.g., to show the “progress” of the slow cooker 10) which allows the user to make decisions via a remote logic in the mobile dashboard, application, or service.

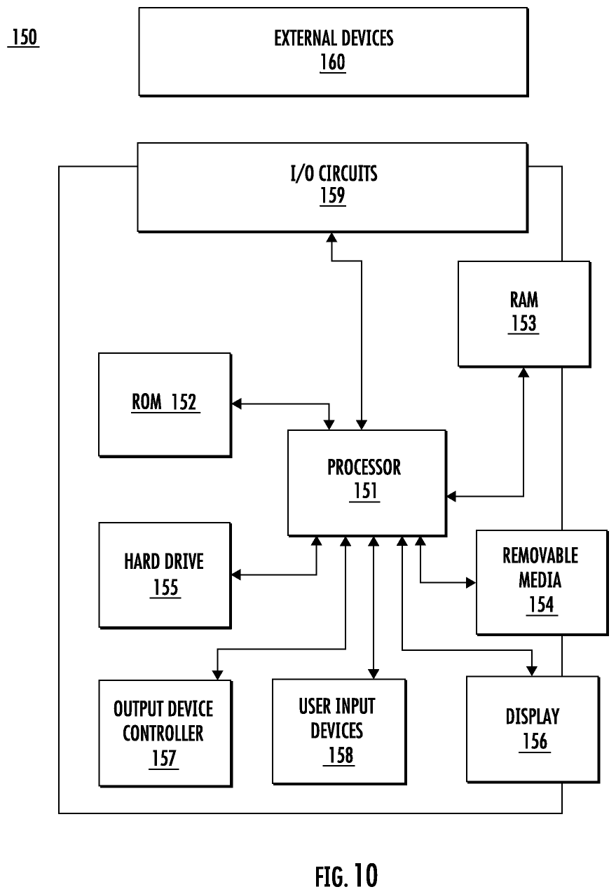

FIG. 10 illustrates hardware elements that can be used to implement any of the various computing devices or components thereof discussed herein (e.g., computing device 150 of FIG. 9). In some aspects, general hardware elements may be used to implement the various devices discussed herein, and those general hardware elements may be specially programmed with instructions that execute the algorithms discussed herein. In special aspects, hardware of a special and non-general design may be employed (e.g., ASIC or the like). Various algorithms and components provided herein may be implemented in hardware, software, firmware, or a combination of the same.

The computing device 150 may include one or more processors 151, which may execute instructions of a computer program to perform any of the features described herein. The instructions may be stored in any type of computer-readable medium or memory, to configure the operation of the processor 151. For example, instructions may be stored in a non-volatile computer memory storage medium such as flash memory, electrically erasable programmable read-only memory (EEPROM), or read-only memory (ROM) 152, random access memory (RAM) 153, removable media 154, such as a Universal Serial Bus (USB) drive, compact disk (CD) or digital versatile disk (DVD), floppy disk drive, or any other desired electronic storage medium. Instructions may also be stored in an attached (or internal) hard drive 155.

The computing device 150 may include one or more output devices, such as a display 156, and may include one or more output device controllers 157, such as a display processor. There may also be one or more user input devices 158, such as a remote control, keyboard, mouse, touch screen, microphone, or the like. The computing device 150 may also include input/output circuits 159 which may include circuits and/or devices configured to enable the computing device 150 to communicate with external devices 160 (e.g., the slow cooker 10). The input/output circuits 159 may include one or more network interfaces, such as a network card, to enable to the computing device 150 to communicate with an external device via an external network (e.g., network 160 of FIG. 9).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A slow cooker, comprising:
an outer housing having a base and a side wall extending therefrom, the side wall having an exterior surface and an opposing interior surface, at least portions of the interior surface of the side wall and base defining a cavity within the outer housing, the outer housing having a housing rim defining an opening to the cavity;
a heating element disposed within the outer housing proximate to the cavity to heat the cavity;
a container having a generally hollow interior and a container rim defining an opening for accessing the interior thereof, the interior being capable of retaining contents therein, the container being sized and shaped to removably fit within the cavity of the outer housing;
a lid sized and shaped to at least partially cover the opening of the container when placed on the container;
a network housing unit mounted to the exterior surface of the side wall of the outer housing; and
a network antenna located in a top portion of the network housing unit such that the network antenna resides above a maximum liquid fill line within the container, wherein the network antenna is in communication with a processor and memory storing non-transitory computer-readable instructions that, when executed by the processor, cause the processor to perform operations comprising:
capturing data with one or more sensors within the outer housing; and
wirelessly transmitting, via a network, notification messages based on the captured data to a remote device.

2. The slow cooker defined in claim 1, wherein the network is a Wi-Fi network.

3. The slow cooker defined in claim 1, wherein the container is a ceramic pot.

4. The slow cooker defined in claim 1, further comprising a pair of side handles, wherein each side handle comprises a wire lid clip, each wire lid clip being pivotable between an engaged position in which at least a portion of the lid clip interlocks with a hook feature on the lid to retain the lid in sealing engagement with the container rim and a disengaged position in which the portion of the lid clip is spaced-apart from the hook feature to permit the lid to be removed from the container rim.

5. The slow cooker defined in claim 1, wherein the network housing unit is configured to serve as a lid rest.

6. The slow cooker defined in claim 1, further comprising a temperature probe accessory.

7. The slow cooker defined in claim 6, wherein the lid comprises one or more openings sized to allow insertion of the temperature probe accessory into the interior of the container.

8. The slow cooker defined in claim 1, wherein the remote device is a smartphone, tablet, smartwatch, or other monitoring/control device.

9. The slow cooker defined in claim 8, wherein at least one operational setting of the slow cooker is controlled via a mobile application, dashboard or service operating on the remote device.

10. A slow cooker, comprising:
an outer housing having a base and a side wall extending therefrom, the side wall having an exterior surface and an opposing interior surface, at least portions of the interior surface of the side wall and base defining a cavity within the outer housing, the outer housing having a housing rim defining an opening to the cavity;
a heating element disposed within the outer housing proximate to the cavity to heat the cavity;
a container having a generally hollow interior and a container rim defining an opening for accessing the interior thereof, the interior being capable of retaining contents therein, the container being sized and shaped to removably fit within the cavity of the outer housing;
a lid sized and shaped to at least partially cover the opening of the container when placed on the container;
a network housing unit mounted to the exterior surface of the side wall of the outer housing; and
a network antenna located in a top portion of the network housing unit such that the network antenna resides above the housing rim of the outer housing, wherein the network antenna is communication with a processor and memory storing non-transitory computer-readable instructions that, when executed by the processor, cause the processor to perform operations comprising:
capturing data with one or more sensors within the outer housing; and
wirelessly transmitting, via a network, notification messages based on the captured data to a remote device.

11. The slow cooker defined in claim 10, wherein the network is a Wi-Fi network.

12. The slow cooker defined in claim 10, wherein the network antenna is configured to wirelessly transmit and receive data to a remote device.

13. The slow cooker defined in claim 12, wherein the remote device is smartphone, tablet, smartwatch, or other monitoring/control device.

14. The slow cooker defined in claim 13, wherein at least one operational setting of the slow cooker is controlled via a mobile application, dashboard, or service operating on the smart device.

15. The slow cooker defined in claim 10, wherein the network housing unit is configured to serve as a lid rest.

16. A slow cooker, comprising:
an outer housing having a base and a side wall extending therefrom, the side wall having an exterior surface and an opposing interior surface, at least portions of the interior surface of the side wall and base defining a cavity within the outer housing, the outer housing having a housing rim defining an opening to the cavity;
a heating element disposed within the outer housing proximate to the cavity to heat the cavity;
a container having a generally hollow interior and a container rim defining an opening for accessing the interior thereof, the interior being capable of retaining contents therein, the container being sized and shaped to removably fit within the cavity of the outer housing;
a lid sized and shaped to at least partially cover the opening of the container when placed on the container;
a network housing unit mounted to the exterior surface of the side wall of the outer housing, wherein the network housing unit is configured to serve as a lid rest; and
a network antenna located in the network housing unit, wherein the network antenna is in communication with a processor and memory storing non-transitory computer-readable instructions that, when executed by the processor, cause the processor to perform operations comprising:
capturing data with one or more sensors within the outer housing; and
wirelessly transmitting, via a network, notification messages based on the captured data to a remote device.

17. The slow cooker defined in claim 16, wherein the network is a Wi-Fi network.

18. The slow cooker defined in claim 16, further comprising one or more sensors within the outer housing configured to capture and wirelessly transmit data/information via the network antenna to a remote device.

19. The slow cooker defined in claim 18, wherein the network antenna is configured to receive one or more control instructions from the remote device to change at least one operational setting for the slow cooker.

20. The slow cooker defined in claim 19, wherein the remote device is smartphone, tablet, smartwatch, or other monitoring/control device.
